(19) United States
(12) Patent Application Publication
(10) Pub. No.: US 2022/0330375 A1
(43) Pub. Date: Oct. 13, 2022

(54) NETWORK NODE, TERMINAL DEVICE AND METHODS FOR CONTROLLING RRC STATE TRANSITION

(71) Applicant: Telefonaktiebolaget LM Ericsson (publ), Stockholm (SE)

(72) Inventors: Zhang Zhang, Beijing (CN); Congchi Zhang, Shanghai (CN); Antonino Orsino, Kirkkonummi (FI)

(21) Appl. No.: 17/634,000

(22) PCT Filed: Aug. 13, 2020
(86) PCT No.: PCT/CN2020/108913

§ 371 Date: Feb. 9, 2022

(30) Foreign Application Priority Data
Aug. 14, 2019 (CN) PCT/CN2019/100645

(51) Int. Cl. H04W 76/25

(52) U.S. Cl. CPC H04W 76/25

(57) ABSTRACT

The present disclosure provides a method in a network node. The method includes: determining, when a terminal device is in a Radio Resource Control, RRC, _CONNECTED state, that one or more RRC state transition conditions associated with a sidelink are met; and keeping the terminal device in the RRC_CONNECTED state.

### TECHNICAL FIELD

The present disclosure relates to wireless communication, and more particularly, to, a network node, a terminal device and methods for controlling Radio Resource Control (RRC) state transition, a network node, a terminal device and methods for facilitating handover of a terminal device capable of transmission over sidelink, a network node, a terminal device and methods for sidelink configuration, as well as a method and a terminal device for facilitating cell selection or reselection.

### BACKGROUND

In the 3^{rd} Generation Partnership Project (3GPP) Release 14 (Rel-14) and Release 15 (Rel-15), extensions for device-to-device communications support Vehicle-to-Anything (V2X) communications, including any combination of direct communications between vehicles, pedestrians and network infrastructures. V2X communications may carry safety or non-safety information, and V2X applications and services may be associated with specific requirements in terms of e.g., latency, reliability, data rates, etc. V2X communications may take advantage of a network infrastructure (when available), but at least basic V2X connectivity should be possible even in case of no network coverage. Providing a Long Term Evolution (LTE) based V2X interface may be advantageous economically due to the LTE's economy of scale and capability of providing a tighter integration between communications with network infrastructures (Vehicle-to-Infrastructure/Network, or V2I/N), pedestrians (Vehicle-to-Pedestrian, or V2P) and other vehicles (Vehicle-to-Vehicle, or V2V), as compared to using a dedicated V2X technology (e.g., Institute of Electrical and Electronic Engineers (IEEE) 802.11p). Here, V2V covers LTE-based communications between vehicles, either via a cellular interface (known as Uu) or via a sidelink interface (known as PC5). V2P covers LTE-based communications between a vehicle and a device carried by an individual (e.g., a handheld terminal carried by a pedestrian, cyclist, driver or passenger), via either a Uu or sidelink (PC5) interface. V2I/N covers LTE-based communications between a vehicle and a roadside unit (RSU) or a network. An RSU is a transportation infrastructure entity (e.g., an entity transmitting speed notifications) that communicates with V2X capable UEs via sidelink (PC5) or Uu. V2N communications are performed via a Uu interface.

In the 5th Generation (5G) or New Radio (NR), the 3GPP Service and System Aspects 1 (SA1) working group has completed new service requirements for future V2X services in Study on Enhancement of 3GPP support for V2X services (FS_eV2X). The SA1 working group has identified 25 use cases for advanced V2X services which will be used in 5G (i.e., in LTE and NR). These use cases are categorized into four use case groups: vehicles platooning, extended sensors, advanced driving and remote driving. Direct unicast transmission over sidelink will be needed in some use cases such as platooning, cooperative driving, dynamic ride sharing, etc. For these advanced applications, the expected requirements on data rate, capacity, reliability, latency, communication range and speed will be more stringent. The consolidated requirements for each use case group are captured in 3GPP Technical Report (TR) 22.886 V16.2.0.

There are two modes of resource allocation procedures for V2X on sidelink: network controlled resource allocation (referred to as “mode 3” in LTE or “mode 1” in NR) and autonomous resource allocation (referred to as “mode 4” in LTE or “mode 2” in NR). In either mode, transmission resources are selected from a resource pool which is predefined or configured by a network node. In the network controlled resource allocation, sidelink radio resources for data transmission are scheduled or allocated by a network node. A terminal device, or User Equipment (UE), sends a sidelink Buffer Status Report (BSR) to the network node, indicating sidelink data available for transmission in a sidelink buffer associated with a Medium Access Control (MAC) entity, and then the network node signals a resource allocation to the UE via Downlink Control Information (DCI). In the autonomous resource allocation, a UE autonomously decides which radio resources to use for sidelink transmission by means of e.g., channel sensing. In both resource allocation modes, Sidelink Control Information (SCI) is transmitted on a Physical Sidelink Control Channel (PSCCH) to indicate the sidelink resources allocated for Physical Sidelink Shared Channel (PSSCH).

The network controlled resource allocation can only be performed when a UE is in an RRC_CONNECTED state, while the autonomous resource allocation can be performed in any of an RRC_CONNECTED state, an RRC_INACTIVE state or an RRC_IDLE state. In the RRC_INACTIVE or RRC_IDLE state, a UE controlled mobility based on a network configuration is adopted. A UE can acquire System Information Broadcast (SIB), perform neighboring cell measurement and cell selection or reselection, and monitor paging messages. In the RRC_CONNECTED state, a network-controlled mobility is performed. A UE in the RRC_CONNECTED state is known by a network node at a node/cell level and a UE specific bearer can be established for transmission of UE specific data and/or control signaling. If there is no data transmission over the Uu interface for a certain time period for example, a network node can initiate an RRC connection release procedure for a UE to transition from the RRC_CONNECTED state to the RRC_IDLE or RRC_INACTIVE state.

### SUMMARY

As discussed above, only the data transmission over the Uu interface is considered in the above RRC state transition, which may adversely affect any ongoing or potential data transmission over sidelink.

In the RRC_CONNECTED state, a terminal device may obtain a sidelink configuration, including e.g., a sidelink resource pool configuration and/or a sidelink Quality of Service (QoS) configuration, via dedicated RRC signaling, and in this case a resource pool exclusive to the terminal device can be configured. In the RRC_INACTIVE or RRC_IDLE state, a terminal device may obtain a sidelink configuration from a SIB provided by a cell it is currently camping on, if available. However, if a sidelink configuration is not available in the SIB, the terminal device, if in coverage, will need to enter the RRC_CONNECTED state to obtain a sidelink configuration via dedicated RRC signaling.

As discussed above, conventionally, if there is no data transmission over the Uu interface for a certain time period, a terminal device will transition from the RRC_CONNECTED state to the RRC_IDLE or RRC_INACTIVE state, even if there is an ongoing transmission over sidelink. If there is no sidelink configuration available in the SIB, the terminal device would have to enter the RRC_CONNECTED state again as described above in order to transmit data over sidelink. This may cause a Ping-Pong effect, i.e., the terminal device may repeatedly switch between the RRC_CONNECTED state and the RRC_IDLE or RRC_INACTIVE state, e.g., when there is no Uu data transmission and a configured grant (especially Type 1 configured grant) or an autonomous resource allocation is adopted for sidelink.

On the other hand, even if a sidelink configuration is available in the SIB, a resource pool indicated in the sidelink configuration in the SIB will be a common resource pool shared by terminal devices in the cell. This means an ongoing transmission over sidelink may have a degraded QoS after being switched from an exclusive resource pool in the RRC_CONNECTED state to a common resource pool in the RRC_IDLE or RRC_INACTIVE state, which is undesired for some services having high QoS requirements, e.g., platooning or cooperative driving.

It is an object of the present disclosure to provide a network node, a terminal device and methods for controlling RRC state transition, and a network node, a terminal device and methods for sidelink configuration, capable of preventing an RRC state transition from adversely affecting any ongoing or potential data transmission over sidelink. Embodiments of the present disclosure also provide a network node, a terminal device and methods for facilitating handover of a terminal device capable of transmission over sidelink, and a method and a terminal device for facilitating cell selection or reselection, capable of optimizing a handover or cell selection (or reselection) procedure while taking RRC state transition and transmission over sidelink into consideration.

According to a first aspect of the present disclosure, a method in a network node is provided. The method includes: determining, when a terminal device is in an RRC_CONNECTED state, that one or more RRC state transition conditions associated with a sidelink are met; and keeping the terminal device in the RRC_CONNECTED state.

In an embodiment, the one or more RRC state transition conditions may include a first condition that no sidelink configuration is available in a SIB from the network node.

In an embodiment, the first condition may further include: no sidelink configuration being available in a SIB from a neighboring cell.

In an embodiment, the first condition may further include: no predefined sidelink configuration being enabled for the terminal device.

In an embodiment, the one or more state transition conditions may include a second condition that there is an ongoing transmission by the terminal device over the sidelink.

In an embodiment, the second condition may further include: the ongoing transmission being associated with a predetermined service type or with a required QoS higher than a QoS threshold.

In an embodiment, the second condition may be determined to be met when: a grant for the sidelink has been provided to the terminal device and is currently active, or a report is received from the terminal device, indicating the ongoing transmission by the terminal device over the sidelink.

In an embodiment, the operation of keeping may include one or more of: setting an inactivity timer to a value larger than a timer value threshold, wherein the inactivity timer is associated with an interface between the network node and the terminal device, refraining from initiating an RRC state transition of the terminal device when the inactivity timer expires, or instructing the terminal device to stay in the RRC_CONNECTED state.

In an embodiment, the sidelink configuration may include a sidelink resource pool configuration and/or a sidelink QoS configuration.

According to a second aspect of the present disclosure, a method in a terminal device is provided. The method includes: determining, when the terminal device is in an RRC_CONNECTED state, that one or more RRC state transition conditions associated with a sidelink are met; and transmitting to a network node a request to stay in the RRC_CONNECTED state.

In an embodiment, the one or more RRC state transition conditions may include a first condition that no sidelink configuration is available in a SIB from the network node.

In an embodiment, the first condition may further include: no sidelink configuration being available in a SIB from a neighboring cell.

In an embodiment, the first condition may further include: no predefined sidelink configuration being enabled for the terminal device.

In an embodiment, the one or more state transition conditions may include a second condition that there is an ongoing transmission by the terminal device over the sidelink.

In an embodiment, the second condition may further include: the ongoing transmission being associated with a predetermined service type or with a required QoS higher than a QoS threshold.

In an embodiment, the second condition may be determined to be met when a grant for the sidelink has been received from the network node and is currently active.

In an embodiment, the method may further include, when the second condition is determined to be met: transmitting to the network node a report indicating the ongoing transmission by the terminal device over the sidelink.

In an embodiment, the method may further include, receiving from the network node an instruction to stay in the RRC_CONNECTED state.

In an embodiment, the sidelink configuration may include a sidelink resource pool configuration and/or a sidelink QoS configuration.

According to a third aspect of the present disclosure, a method in a network node is provided. The method includes: determining that a first target cell provides a sidelink configuration in a first SIB and a second target cell provides no sidelink configuration in a second SIB; and transmitting a handover command to a terminal device based on a handover decision made by prioritizing the first target cell over the second target cell.

In an embodiment, the operation of prioritizing may be performed in response to determining that the terminal device does not have any ongoing transmission over a sidelink that is associated with a predetermined service type or with a required QoS higher than a QoS threshold.

In an embodiment, the sidelink configuration may include a sidelink resource pool configuration and/or a sidelink QoS configuration.

According to a fourth aspect of the present disclosure, a method in a terminal device is provided. The method includes: determining that a first target cell provides a sidelink configuration in a first SIB and a second target cell provides no sidelink configuration in a second SIB; and transmitting to a network node a measurement report containing information on at least one target cell candidate for handover, the information being determined by prioritizing the first target cell over the second target cell.

In an embodiment, the operation of prioritizing may be performed in response to determining that the terminal device does not have any ongoing transmission over a sidelink that is associated with a predetermined service type or with a required QoS higher than a QoS threshold.

In an embodiment, the sidelink configuration may include a sidelink resource pool configuration and/or a sidelink QoS configuration.

According to a fifth aspect of the present disclosure, a method in a network node is provided. The method includes: determining a sidelink configuration to be used by a terminal device while in an RRC_INACTIVE or an RRC_IDLE state; and transmitting the sidelink configuration to the terminal device via RRC signaling.

In an embodiment, the sidelink configuration may include a sidelink resource pool configuration and/or a sidelink QoS configuration.

In an embodiment, the method may further include: transmitting to the terminal device a command to transition from an RRC_CONNECTED state to the RRC_INACTIVE or RRC_IDLE state. The sidelink configuration may be included in the command.

In an embodiment, the sidelink configuration may be determined and/or transmitted in response to determining that there is an ongoing transmission by the terminal device over a sidelink.

In an embodiment, the sidelink configuration may include a grant for the sidelink.

In an embodiment, the sidelink configuration may be to override a sidelink configuration transmitted to the terminal device via SIB.

According to a sixth aspect of the present disclosure, a method in a terminal device is provided. The method includes: receiving, from a network node via RRC signaling, a sidelink configuration to be used by the terminal device while in an RRC_INACTIVE or an RRC_IDLE state; and performing a sidelink transmission in accordance with the sidelink configuration after transition to the RRC_INACTIVE or RRC_IDLE state.

In an embodiment, the sidelink configuration may include a sidelink resource pool configuration and/or a sidelink QoS configuration.

In an embodiment, the method may further include: receiving from the network node a command to transition from an RRC_CONNECTED state to the RRC_INACTIVE or RRC_IDLE state. The sidelink configuration may be included in the command.

In an embodiment, the terminal device may have an ongoing transmission over a sidelink when the sidelink configuration is received.

In an embodiment, the sidelink configuration may include a grant for the sidelink.

In an embodiment, the sidelink configuration may be to override a sidelink configuration received from the network node via SIB.

According to a seventh aspect of the present disclosure, a method in a terminal device is provided. The method includes: determining that a predefined sidelink configuration is enabled in a first cell and/or frequency and/or Radio Access Technology (RAT), and no predefined sidelink configuration is enabled in a second cell and/or frequency and/or RAT, and that no sidelink configuration is available in a SIB from the second cell and/or frequency and/or RAT; and prioritizing the first cell and/or frequency and/or RAT over the second cell and/or frequency and/or RAT in a cell selection or reselection procedure for the terminal device.

In an embodiment, the sidelink configuration may include a sidelink resource pool configuration and/or a sidelink QoS configuration.

According to an eighth aspect of the present disclosure, a network node is provided. The network node includes a processor and a memory. The memory contains instructions executable by the processor whereby the network node is operative to perform the method according to any of the above first, third and fifth aspects.

According to a ninth aspect of the present disclosure, a computer readable storage medium is provided. The computer readable storage medium has computer program instructions stored thereon. The computer program instructions, when executed by a processor in a network node, cause the network node to perform the method according to any of the above first, third and fifth aspects.

According to a tenth aspect of the present disclosure, a terminal device is provided. The terminal device includes a processor and a memory. The memory contains instructions executable by the processor whereby the terminal device is operative to perform the method according to any of the above second, fourth, sixth and seventh aspects.

According to an eleventh aspect of the present disclosure, a computer readable storage medium is provided. The computer readable storage medium has computer program instructions stored thereon. The computer program instructions, when executed by a processor in a terminal device, cause the terminal device to perform the method according to any of the above second, fourth, sixth and seventh aspects.

According to a twelfth aspect of the present disclosure, a communication system is provided. The communication system includes a host computer including: processing circuitry configured to provide user data; and a communication interface configured to forward the user data to a cellular network for transmission to a UE. The cellular network includes a base station having a radio interface and processing circuitry. The base station's processing circuitry is configured to perform the method according to any of the above second, fourth, sixth and seventh aspects.

In an embodiment, the communication system can further include the base station.

In an embodiment, the communication system can further include the UE. The UE is configured to communicate with the base station.

In an embodiment, the processing circuitry of the host computer can be configured to execute a host application, thereby providing the user data. The UE can include processing circuitry configured to execute a client application associated with the host application.

According to a thirteenth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The base station can perform the method according to any of the above second, fourth, sixth and seventh aspects.

In an embodiment, the method further can include: at the base station, transmitting the user data.

In an embodiment, the user data can be provided at the host computer by executing a host application. The method can further include: at the UE, executing a client application associated with the host application.

According to a fourteenth aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform the method according to any of the above first, third and fifth aspects.

In an embodiment, the communication system can further include the UE.

In an embodiment, the cellular network can further include a base station configured to communicate with the UE.

In an embodiment, the processing circuitry of the host computer can be configured to execute a host application, thereby providing the user data. The UE's processing circuitry can be configured to execute a client application associated with the host application.

According to a fifteenth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The UE can perform the method according to any of the above first, third and fifth aspects.

In an embodiment, the method can further include: at the UE, receiving the user data from the base station.

According to a sixteenth aspect of the present disclosure, a communication system is provided. The communication system includes a host computer including: a communication interface configured to receive user data originating from a transmission from a UE to a base station. The UE includes a radio interface and processing circuitry. The UE's processing circuitry is configured to: perform the method according to any of the above first, third and fifth aspects.

In an embodiment, the communication system can further include the UE.

In an embodiment, the communication system can further include the base station. The base station can include a radio interface configured to communicate with the UE and a communication interface configured to forward to the host computer the user data carried by a transmission from the UE to the base station.

In an embodiment, the processing circuitry of the host computer can be configured to execute a host application. The UE's processing circuitry can be configured to execute a client application associated with the host application, thereby providing the user data.

In an embodiment, the processing circuitry of the host computer can be configured to execute a host application, thereby providing request data. The UE's processing circuitry can be configured to execute a client application associated with the host application, thereby providing the user data in response to the request data.

According to a seventeenth aspect of the present disclosure, a method is provided. The method is implemented in a communication system including a host computer, a base station and a UE. The method includes: at the host computer, receiving user data transmitted to the base station from the UE. The UE can perform the method according to any of the above first, third and fifth aspects.

In an embodiment, the method can further include: at the UE, providing the user data to the base station.

In an embodiment, the method can further include: at the UE, executing a client application, thereby providing the user data to be transmitted; and at the host computer, executing a host application associated with the client application.

In an embodiment, the method can further include: at the UE, executing a client application; and at the UE, receiving input data to the client application, the input data being provided at the host computer by executing a host application associated with the client application. The user data to be transmitted is provided by the client application in response to the input data.

According to an eighteenth aspect of the present disclosure, a communication system is provided. The communication system includes a host computer including a communication interface configured to receive user data originating from a transmission from a UE to a base station. The base station includes a radio interface and processing circuitry. The base station's processing circuitry is configured to perform the method according to any of the above tenth to second, fourth, sixth and seventh aspects.

In an embodiment, the communication system can further include the base station.

In an embodiment, the communication system can further include the UE. The UE can be configured to communicate with the base station.

In an embodiment, the processing circuitry of the host computer can be configured to execute a host application; the UE can be configured to execute a client application associated with the host application, thereby providing the user data to be received by the host computer.

According to a nineteenth aspect of the present disclosure, a method is provided. The method is implemented in a communication system including a host computer, a base station and a UE. The method includes: at the host computer, receiving, from the base station, user data originating from a transmission which the base station has received from the UE. The base station can perform the method according to any of the above second, fourth, sixth and seventh aspects.

In an embodiment, the method can further include: at the base station, receiving the user data from the UE.

In an embodiment, the method can further include: at the base station, initiating a transmission of the received user data to the host computer.

With the solutions according to at least some of the embodiments of the present disclosure, it is possible to prevent an RRC state transition from adversely affecting any ongoing or potential data transmission over sidelink. With the solutions according to at least some of the embodiments of the present disclosure, it is possible to improve transmission over sidelink by optimizing a handover or cell selection (or reselection) procedure while taking RRC state transition and transmission over sidelink into consideration.

### BRIEF DESCRIPTION OF THE DRAWINGS

The above and other objects, features and advantages will be more apparent from the following description of embodiments with reference to the figures, in which:

FIG. 1 is a flowchart illustrating a method in a network node according to an embodiment of the present disclosure;

FIG. 2 is a flowchart illustrating a method in a terminal device according to an embodiment of the present disclosure;

FIG. 3 is a flowchart illustrating a method in a network node according to another embodiment of the present disclosure;

FIG. 4 is a flowchart illustrating a method in a terminal device according to another embodiment of the present disclosure;

FIG. 5 is a flowchart illustrating a method in a network node according to yet another embodiment of the present disclosure;

FIG. 6 is a flowchart illustrating a method in a terminal device according to yet another embodiment of the present disclosure;

FIG. 7 is a flowchart illustrating a method in a terminal device according to still yet an embodiment of the present disclosure;

FIG. 8 is a block diagram of a network node according to an embodiment of the present disclosure;

FIG. 9 is a block diagram of a network node according to another embodiment of the present disclosure;

FIG. 10 is a block diagram of a terminal device according to an embodiment of the present disclosure;

FIG. 11 is a block diagram of a terminal device according to another embodiment of the present disclosure;

FIG. 12 schematically illustrates a telecommunication network connected via an intermediate network to a host computer;

FIG. 13 is a generalized block diagram of a host computer communicating via a base station with a user equipment over a partially wireless connection; and

FIGS. 14 to 17 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or (next) generation NodeB (gNB), a Remote Radio Unit (RRU), a radio header (RH), a remote radio head (RRH), a relay, a low power node such as a femto, a pico, and so forth. Yet further examples of the network node or network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

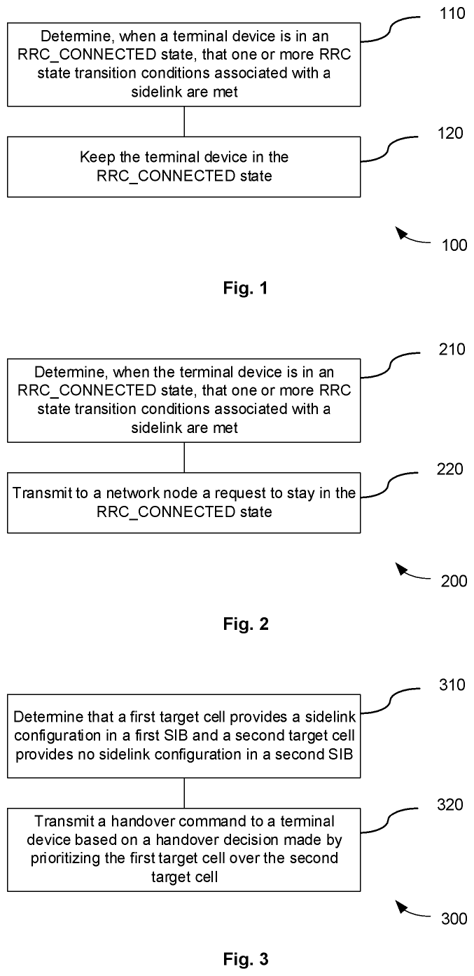

FIG. 1 is a flowchart illustrating a method 100 according to an embodiment of the present disclosure. The method 100 can be performed in a network node, e.g., a gNB.

At block 110, it is determined that one or more RRC state transition conditions associated with a sidelink are met when a terminal device is in an RRC_CONNECTED state.

At block 120, the terminal device is kept in the RRC_CONNECTED state.

In an example, the one or more RRC state transition conditions may include a first condition that no sidelink configuration is available in a SIB from the network node. For example, when no sidelink configuration is available in the SIB from the network node, the terminal device may not be able to perform transmission over the sidelink after transition to an RRC_INACTIVE or an RRC_IDLE state. In this case, the terminal device can be kept in the RRC_CONNECTED state, even if a Uu-based condition is met (e.g., if there is no data transmission over the Uu interface for a certain time period).

In an example, the first condition may further include: no sidelink configuration being available in a SIB from a neighboring cell, in addition to no sidelink configuration being available in the SIB from the network node. For example, when no sidelink configuration is available in the SIB from the network node but the terminal device can find a neighboring cell, which can provide a sidelink configuration in a SIB, to camp on, the terminal device can still transition from the RRC_CONNECTED state to the RRC_INACTIVE or RRC_IDLE state when a Uu-based condition is met. On the other hand, if no sidelink configuration is available in the SIB from the network node and the terminal device cannot find such a neighboring cell, it can be kept in the RRC_CONNECTED state even if the Uu-based condition is met. Here, the neighboring cell may or may not have the same frequency and/or Radio Access Technology (RAT) as a current serving cell provided by the network node. The network node can obtain information on whether a neighboring cell provides a sidelink configuration via SIB, e.g., from the neighboring cell, and notify the terminal device of the information via dedicated and/or common signaling. Alternatively, the terminal device can obtain such information by reading the SIB from the neighboring cell and report it to the network node, such that the network node can control the RRC state transition of the terminal device properly.

In an example, the first condition may further include: no predefined sidelink configuration being enabled for the terminal device, in addition to no sidelink configuration being available in the SIB from the network node and/or no sidelink configuration being available in a SIB from a neighboring cell. For example, when no sidelink configuration is available in the SIB from the network node (and optionally when the terminal device cannot find a neighboring cell providing a sidelink configuration in a SIB to camp on) but a predefined sidelink configuration is enabled for the terminal device, the terminal device can still transition from the RRC_CONNECTED state to the RRC_INACTIVE or RRC_IDLE state when a Uu-based condition is met. On the other hand, if no sidelink configuration is available in the SIB from the network node (and optionally when the terminal device cannot find such a neighboring cell) and no predefined sidelink configuration is enabled for the terminal device, the terminal device can be kept in the RRC_CONNECTED state even if the Uu-based condition is met.

Additionally or alternatively to the above first condition, the one or more state transition conditions may include a second condition that there is an ongoing transmission by the terminal device over the sidelink. For example, as discussed above, an ongoing transmission over sidelink may have a degraded QoS after being switched from an exclusive resource pool in the RRC_CONNECTED state to a common resource pool in the RRC_IDLE or RRC_INACTIVE state. Thus, when there is an ongoing transmission by the terminal device over the sidelink, the terminal device can be kept in the RRC_CONNECTED state even if the Uu-based condition is met.

As an example, the second condition can be determined to be met when a grant (e.g., a configured grant) for the sidelink has been provided to the terminal device and is currently active (e.g., for the “mode 1” in NR). As another example, the second condition can be determined to be met when a report is received from the terminal device, indicating the ongoing transmission by the terminal device over the sidelink (e.g., for the “mode 2” in NR).

In an example, the second condition may further include: the ongoing transmission being associated with a predetermined service type or with a required QoS higher than a QoS threshold. For example, when the ongoing transmission over the sidelink is associated with a service having high QoS requirements, e.g., platooning or cooperative driving, or when the ongoing transmission over the sidelink requires a higher QoS than a QoS threshold, e.g., a higher data rate than a data rate threshold or a lower latency than a latency threshold, the terminal device can be kept in the RRC_CONNECTED state even if the Uu-based condition is met. The network node can configure, via dedicated or common signaling, which service type(s) over the sidelink would require the terminal device to be kept in the RRC_CONNECTED state, or the service type(s) can be predefined in the network node and/or the terminal device. The network node can know the service type of the ongoing transmission from e.g., SidelinkUEInformation reported by the terminal device.

The one or more conditions can be configured by the network node to the terminal device via dedicated or common signaling, or can be predefined in the network node and/or the terminal device.

The sidelink configuration can include a sidelink resource pool configuration and/or a sidelink QoS configuration. The sidelink QoS configuration may include a Sidelink QoS flow and Sidelink Radio Bearer (SLRB) configuration, e.g., including QoS parameters associated with each sidelink QoS flow and a mapping of sidelink QoS flows to SLRBs.

In an example, in the block 120, in order to keep the terminal device in the RRC_CONNECTED state, an inactivity timer associated with an interface between the network node and the terminal device (e.g., a Uu interface) can be set to a value larger than a timer value threshold, e.g., to infinite, a maximum allowed value or any value that is sufficiently large so that the inactivity timer would not expire in practice. Alternatively, the network node can refrain from initiating an RRC state transition of the terminal device (i.e., from the RRC_CONNECTED state to the RRC_IDLE or RRC_INACTIVE state) when the inactivity timer expires. Alternatively, the network node can instruct the terminal device to stay in the RRC_CONNECTED state, e.g., explicitly via RRC signaling.

FIG. 2 is a flowchart illustrating a method 200 according to an embodiment of the present disclosure. The method 200 can be performed in a terminal device, e.g., a UE (in particular a UE capable of sidelink communication, e.g., a V2X UE).

At block 210, it is determined that one or more RRC state transition conditions associated with a sidelink are met when the terminal device is in an RRC_CONNECTED state.

At block 220, a request to stay in the RRC_CONNECTED state is transmitted to a network node.

In an example, the one or more RRC state transition conditions may include a first condition that no sidelink configuration is available in a SIB from the network node. The first condition may further include: no sidelink configuration being available in a SIB from a neighboring cell. The first condition may further include: no predefined sidelink configuration being enabled for the terminal device.

In an example, the one or more state transition conditions may include a second condition that there is an ongoing transmission by the terminal device over the sidelink. The second condition may further include: the ongoing transmission being associated with a predetermined service type or with a required QoS higher than a QoS threshold.

For further details of the first and second conditions, reference can be made to the above description in connection with the method 100 shown in FIG. 1.

In an example, the second condition may be determined to be met when a grant for the sidelink has been received from the network node and is currently active (e.g., for the “mode 1” in NR). In another embodiment, when the second condition is determined to be met (e.g., for the “mode 2” in NR), a report can be transmitted to the network node, indicating the ongoing transmission by the terminal device over the sidelink.

In an example, an instruction to stay in the RRC_CONNECTED state can be received from the network node, e.g., explicitly via RRC signaling.

In an example, the sidelink configuration may include a sidelink resource pool configuration and/or a sidelink QoS configuration.

FIG. 3 is a flowchart illustrating a method 300 according to an embodiment of the present disclosure. The method 300 can be performed in a network node, e.g., a gNB.

At block 310, it is determined that a first target cell provides a sidelink configuration in a first SIB and a second target cell provides no sidelink configuration in a second SIB. Here, the sidelink configuration may include a sidelink resource pool configuration and/or a sidelink QoS configuration.

At block 320, a handover command is transmitted to a terminal device based on a handover decision made by prioritizing the first target cell over the second target cell.

In particular, the handover decision can be made to initiate handover of the terminal device to the first target cell, regardless of whether or not the first target cell has a higher measured signal strength than the second target cell.

In an example, optionally, the operation of prioritizing can be performed in response to determining that the terminal device does not have any ongoing transmission over a sidelink that is associated with a predetermined service type or with a required QoS higher than a QoS threshold. If the terminal device has such an ongoing transmission, it may be kept in the RRC_CONNECTED state so as to use an exclusive resource pool, instead of using a common resource pool configured via a SIB.

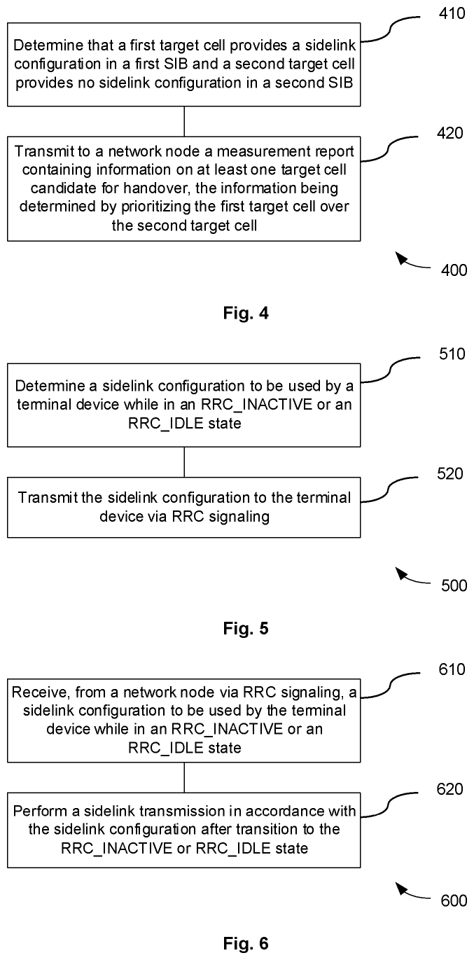

FIG. 4 is a flowchart illustrating a method 400 according to an embodiment of the present disclosure. The method 400 can be performed in a terminal device, e.g., a UE (in particular a UE capable of sidelink communication, e.g., a V2X UE).

At block 410, it is determined that a first target cell provides a sidelink configuration in a first SIB and a second target cell provides no sidelink configuration in a second SIB. Here, the sidelink configuration may include a sidelink resource pool configuration and/or a sidelink QoS configuration.

At block 420, a measurement report is transmitted to a network node. The measurement report contains information on at least one target cell candidate for handover. The information is determined by prioritizing the first target cell over the second target cell.

In particular, the above information may be e.g., a target cell candidate list that includes the first target cell but not the second target cell, regardless of whether or not the first target cell has a higher measured signal strength than the second target cell. Alternatively, the above information may indicate a first signal strength of the first target cell and a second signal strength of the second target cell, and the first signal strength may have been adjusted by adding a positive offset to a measured signal strength of the first target cell. Alternatively, the above information may simply indicate that the first target cell is to be prioritized over the second target cell and it is up to the network node to decide how to perform the prioritization.

FIG. 5 is a flowchart illustrating a method 500 according to an embodiment of the present disclosure. The method 500 can be performed in a network node, e.g., a gNB.

At block 510, a sidelink configuration is determined. The sidelink configuration is to be used by a terminal device while in an RRC_INACTIVE or an RRC_IDLE state. Here, the sidelink configuration may include a sidelink resource pool configuration and/or a sidelink QoS configuration.

At block 520, the sidelink configuration is transmitted to the terminal device via RRC signaling.

In an example, when a Uu-based condition is met (e.g., if there is no data transmission over the Uu interface for a certain time period), a command to transition from an RRC_CONNECTED state to the RRC_INACTIVE or RRC_IDLE state can be transmitted to the terminal device. The sidelink configuration can be included in the command for transmission to the terminal device. Alternatively, the sidelink configuration can be transmitted to the terminal device before the command.

In an example, the sidelink configuration can be determined in the block 510 and/or transmitted in the block 520 in response to determining that there is an ongoing transmission by the terminal device over a sidelink. In this case, the sidelink configuration may further include a grant for the sidelink, which is to be used by the terminal device for continuing with the transmission in the RRC_INACTIVE or RRC_IDLE state.

In this way, for example, when there is an ongoing transmission over the sidelink (e.g., for the “mode 1” in NR) while the Uu-based condition is met, the network node can initiate a transition of the terminal device's RRC state from the RRC_CONNECTED state to the RRC_INACTIVE or RRC_IDLE state and the terminal device can still use a dedicated sidelink resource pool configured in the sidelink configuration via the RRC signaling.

The sidelink configuration can override a sidelink configuration (if any) transmitted to the terminal device via SIB. The terminal device can use the sidelink configuration while in the RRC_INACTIVE or RRC_IDLE state, until it enters the RRC_CONNECTED state again or moves out of coverage.

FIG. 6 is a flowchart illustrating a method 600 according to an embodiment of the present disclosure. The method 600 can be performed in a terminal device, e.g., a UE (in particular a UE capable of sidelink communication, e.g., a V2X UE).

At block 610, a sidelink configuration is received from a network node via RRC signaling. The sidelink configuration is to be used by the terminal device while in an RRC_INACTIVE or an RRC_IDLE state. Here, the sidelink configuration may include a sidelink resource pool configuration and/or a sidelink QoS configuration.

At block 620, a sidelink transmission is performed in accordance with the sidelink configuration after transition to the RRC_INACTIVE or RRC_IDLE state.

In an example, a command to transition from an RRC_CONNECTED state to the RRC_INACTIVE or RRC_IDLE state can be received from the network node, e.g., when a Uu-based condition is met. The sidelink configuration can be included in the command. Alternatively, the sidelink configuration can be received before the command.

In an example, the terminal device may have an ongoing transmission over a sidelink when the sidelink configuration is received. In this case, the sidelink configuration may further include a grant for the sidelink, which is to be used by the terminal device for continuing with the transmission in the RRC_INACTIVE or RRC_IDLE state.

In this way, for example, after transition from the RRC_CONNECTED state to the RRC_INACTIVE or RRC_IDLE state, the terminal device can still use a dedicated sidelink resource pool configured in the sidelink configuration via the RRC signaling.

In an example, the sidelink configuration can override a sidelink configuration (if any) received from the network node via SIB. The terminal device can use the sidelink configuration while in the RRC_INACTIVE or RRC_IDLE state, until it enters the RRC_CONNECTED state again or moves out of coverage.

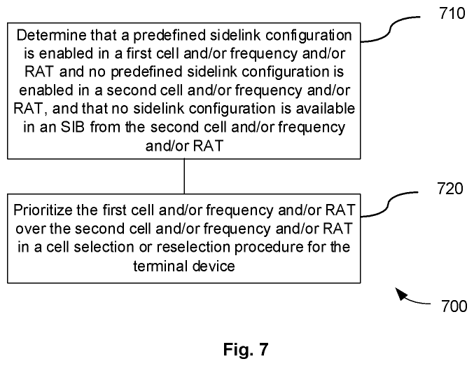

FIG. 7 is a flowchart illustrating a method 700 according to an embodiment of the present disclosure. The method 700 can be performed in a terminal device, e.g., a UE (in particular a UE capable of sidelink communication, e.g., a V2X UE).

At block 710, it is determined that a predefined sidelink configuration is enabled in a first cell and/or frequency and/or Radio Access Technology (RAT), and no predefined sidelink configuration is enabled in a second cell and/or frequency and/or RAT, and that no sidelink configuration is available in a SIB from the second cell and/or frequency and/or RAT. Here, the sidelink configuration may include a sidelink resource pool configuration and/or a sidelink QoS configuration.

At block 720, the first cell and/or frequency and/or RAT is prioritized over the second cell and/or frequency and/or RAT in a cell selection or reselection procedure for the terminal device.

In particular, in the block 720, the terminal device may for example select the first cell and/or frequency and/or RAT to camp on, as long as the terminal device is in coverage of first cell and/or frequency and/or RAT, e.g., regardless of whether or not the first cell and/or frequency and/or RAT has a higher measured signal strength than the second cell and/or frequency and/or RAT.

In this way, the terminal device can use the predefined sidelink configuration while in the RRC_INACTIVE or RRC_IDLE state, without having to transition to the RRC_CONNECTED state to obtain a sidelink configuration.

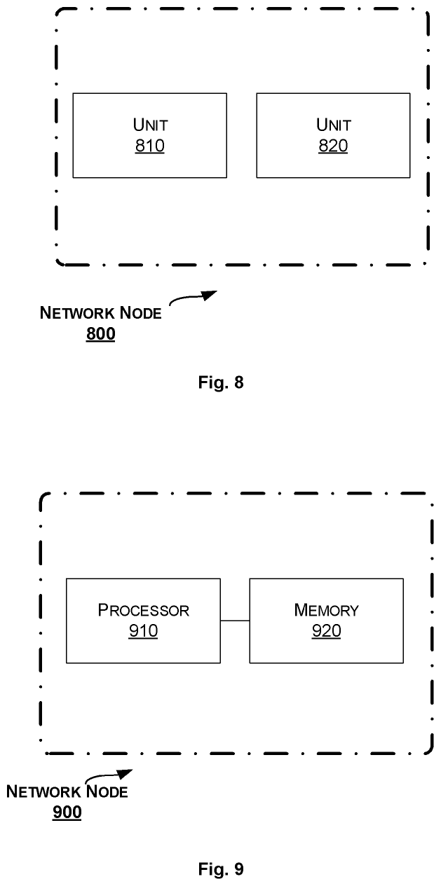

Correspondingly to the methods 100, 300 and 500 as described above, a network node is provided. FIG. 8 is a block diagram of a network node 800 according to an embodiment of the present disclosure.

The network node 800 can be configured to perform the method 100 as described above in connection with FIG. 1. As shown in FIG. 8, the network node 800 includes a unit 810 (e.g., a determining unit) configured to determine, when a terminal device is in an RRC_CONNECTED state, that one or more RRC state transition conditions associated with a sidelink are met. The network node 800 further includes a unit 820 (e.g., a control unit) configured to keep the terminal device in the RRC_CONNECTED state.

In an embodiment, the one or more RRC state transition conditions may include a first condition that no sidelink configuration is available in a SIB from the network node.

In an embodiment, the first condition may further include: no sidelink configuration being available in a SIB from a neighboring cell.

In an embodiment, the first condition may further include: no predefined sidelink configuration being enabled for the terminal device.

In an embodiment, the one or more state transition conditions may include a second condition that there is an ongoing transmission by the terminal device over the sidelink.

In an embodiment, the second condition may further include: the ongoing transmission being associated with a predetermined service type or with a required QoS higher than a QoS threshold.

In an embodiment, the second condition may be determined to be met when: a grant for the sidelink has been provided to the terminal device and is currently active, or a report is received from the terminal device, indicating the ongoing transmission by the terminal device over the sidelink.

In an embodiment, the unit 820 may be configured to keep the terminal device in the RRC_CONNECTED state by one or more of: setting an inactivity timer to a value larger than a timer value threshold, wherein the inactivity timer is associated with an interface between the network node and the terminal device, refraining from initiating an RRC state transition of the terminal device when the inactivity timer expires, or instructing the terminal device to stay in the RRC_CONNECTED state.

In an embodiment, the sidelink configuration may include a sidelink resource pool configuration and/or a sidelink QoS configuration.

Alternatively, the network node 800 can be configured to perform the method 300 as described above in connection with FIG. 3. As shown in FIG. 8, the network node 800 includes a unit 810 (e.g., a determining unit) configured to determine that a first target cell provides a sidelink configuration in a first SIB and a second target cell provides no sidelink configuration in a second SIB. The network node 800 further includes a unit 820 (e.g., a transmitting unit) configured to transmit a handover command to a terminal device based on a handover decision made by prioritizing the first target cell over the second target cell.

In an embodiment, the operation of prioritizing may be performed in response to determining that the terminal device does not have any ongoing transmission over a sidelink that is associated with a predetermined service type or with a required QoS higher than a QoS threshold.

In an embodiment, the sidelink configuration may include a sidelink resource pool configuration and/or a sidelink QoS configuration.

Alternatively, the network node 800 can be configured to perform the method 500 as described above in connection with FIG. 5. As shown in FIG. 8, the network node 800 includes a unit 810 (e.g., a determining unit) configured to determine a sidelink configuration to be used by a terminal device while in an RRC_INACTIVE or an RRC_IDLE state. The network node 800 further includes a unit 820 (e.g., a transmitting unit) configured to transmit the sidelink configuration to the terminal device via RRC signaling.

In an embodiment, the sidelink configuration may include a sidelink resource pool configuration and/or a sidelink QoS configuration.

In an embodiment, the method may further include: transmitting to the terminal device a command to transition from an RRC_CONNECTED state to the RRC_INACTIVE or RRC_IDLE state. The sidelink configuration may be included in the command.

In an embodiment, the sidelink configuration may be determined and/or transmitted in response to determining that there is an ongoing transmission by the terminal device over a sidelink.

In an embodiment, the sidelink configuration may include a grant for the sidelink.

In an embodiment, the sidelink configuration may be to override a sidelink configuration transmitted to the terminal device via SIB.

The above units 810-820 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in any of FIGS. 1, 3 and 5.

FIG. 9 is a block diagram of a network node 900 according to another embodiment of the present disclosure.

The network node 900 includes a processor 910 and a memory 920. The network node 900 can further include a transceiver, e.g., for communication over a Uu interface.

The memory 920 can contain instructions executable by the processor 910 whereby the network node 900 is operative to perform the actions, e.g., of the procedure described earlier in conjunction with FIG. 1. Particularly, the memory 920 can contain instructions executable by the processor 910 whereby the network node 900 is operative to: determine, when a terminal device is in an RRC_CONNECTED state, that one or more RRC state transition conditions associated with a sidelink are met; and keep the terminal device in the RRC_CONNECTED state.

In an embodiment, the one or more RRC state transition conditions may include a first condition that no sidelink configuration is available in a SIB from the network node.

In an embodiment, the first condition may further include: no sidelink configuration being available in a SIB from a neighboring cell.

In an embodiment, the first condition may further include: no predefined sidelink configuration being enabled for the terminal device.

In an embodiment, the one or more state transition conditions may include a second condition that there is an ongoing transmission by the terminal device over the sidelink.

In an embodiment, the second condition may further include: the ongoing transmission being associated with a predetermined service type or with a required QoS higher than a QoS threshold.

In an embodiment, the second condition may be determined to be met when: a grant for the sidelink has been provided to the terminal device and is currently active, or a report is received from the terminal device, indicating the ongoing transmission by the terminal device over the sidelink.

In an embodiment, the operation of keeping may include one or more of: setting an inactivity timer to a value larger than a timer value threshold, wherein the inactivity timer is associated with an interface between the network node and the terminal device, refraining from initiating an RRC state transition of the terminal device when the inactivity timer expires, or instructing the terminal device to stay in the RRC_CONNECTED state.

In an embodiment, the sidelink configuration may include a sidelink resource pool configuration and/or a sidelink QoS configuration.

Alternatively, the memory 920 can contain instructions executable by the processor 910 whereby the network node 900 is operative to perform the actions, e.g., of the procedure described earlier in conjunction with FIG. 3. Particularly, the memory 920 can contain instructions executable by the processor 910 whereby the network node 900 is operative to: determine that a first target cell provides a sidelink configuration in a first SIB and a second target cell provides no sidelink configuration in a second SIB; and transmit a handover command to a terminal device based on a handover decision made by prioritizing the first target cell over the second target cell.

In an embodiment, the operation of prioritizing may be performed in response to determining that the terminal device does not have any ongoing transmission over a sidelink that is associated with a predetermined service type or with a required QoS higher than a QoS threshold.

In an embodiment, the sidelink configuration may include a sidelink resource pool configuration and/or a sidelink QoS configuration.

Alternatively, the memory 920 can contain instructions executable by the processor 910 whereby the network node 900 is operative to perform the actions, e.g., of the procedure described earlier in conjunction with FIG. 5. Particularly, the memory 920 can contain instructions executable by the processor 910 whereby the network node 900 is operative to: determine a sidelink configuration to be used by a terminal device while in an RRC_INACTIVE or an RRC_IDLE state; and transmit the sidelink configuration to the terminal device via RRC signaling.

In an embodiment, the sidelink configuration may include a sidelink resource pool configuration and/or a sidelink QoS configuration.

In an embodiment, the memory 920 can further contain instructions executable by the processor 910 whereby the network node 900 is operative to: transmit to the terminal device a command to transition from an RRC_CONNECTED state to the RRC_INACTIVE or RRC_IDLE state. The sidelink configuration may be included in the command.

In an embodiment, the sidelink configuration may be determined and/or transmitted in response to determining that there is an ongoing transmission by the terminal device over a sidelink.

In an embodiment, the sidelink configuration may include a grant for the sidelink.

In an embodiment, the sidelink configuration may be to override a sidelink configuration transmitted to the terminal device via SIB.

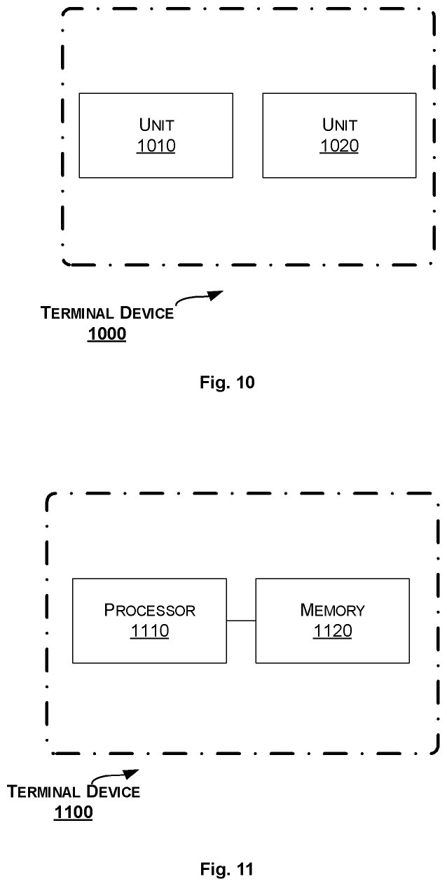

Correspondingly to the methods 200, 400, 600 and 700 as described above, a terminal device is provided. FIG. 10 is a block diagram of a terminal device 1000 according to an embodiment of the present disclosure.

The terminal device 1000 can be configured to perform the method 200 as described above in connection with FIG. 2. As shown in FIG. 10, the terminal device 1000 includes a unit 1010 (e.g., a determining unit) configured to determine, when the terminal device is in an RRC_CONNECTED state, that one or more RRC state transition conditions associated with a sidelink are met. The terminal device 1000 further includes a unit 1020 (e.g., a transmitting unit) configured to transmit to a network node a request to stay in the RRC_CONNECTED state.

In an embodiment, the one or more RRC state transition conditions may include a first condition that no sidelink configuration is available in a SIB from the network node.

In an embodiment, the first condition may further include: no sidelink configuration being available in a SIB from a neighboring cell.

In an embodiment, the first condition may further include: no predefined sidelink configuration being enabled for the terminal device.

In an embodiment, the one or more state transition conditions may include a second condition that there is an ongoing transmission by the terminal device over the sidelink.

In an embodiment, the second condition may further include: the ongoing transmission being associated with a predetermined service type or with a required QoS higher than a QoS threshold.

In an embodiment, the second condition may be determined to be met when a grant for the sidelink has been received from the network node and is currently active.

In an embodiment, the unit 1020 may be further configured to, when the second condition is determined to be met: transmit to the network node a report indicating the ongoing transmission by the terminal device over the sidelink.

In an embodiment, the terminal device 1000 may further include a unit (e.g., a receiving unit) configured to receive from the network node an instruction to stay in the RRC_CONNECTED state.

In an embodiment, the sidelink configuration may include a sidelink resource pool configuration and/or a sidelink QoS configuration.

Alternatively, the terminal device 1000 can be configured to perform the method 400 as described above in connection with FIG. 4. As shown in FIG. 10, the terminal device 1000 includes a unit 1010 (e.g., a determining unit) configured to determine that a first target cell provides a sidelink configuration in a first SIB and a second target cell provides no sidelink configuration in a second SIB. The terminal device 1000 further includes a unit 1020 (e.g., a transmitting unit) configured to transmit to a network node a measurement report containing information on at least one target cell candidate for handover, the information being determined by prioritizing the first target cell over the second target cell.

In an embodiment, the operation of prioritizing may be performed in response to determining that the terminal device does not have any ongoing transmission over a sidelink that is associated with a predetermined service type or with a required QoS higher than a QoS threshold.

In an embodiment, the sidelink configuration may include a sidelink resource pool configuration and/or a sidelink QoS configuration.

Alternatively, the terminal device 1000 can be configured to perform the method 600 as described above in connection with FIG. 6. As shown in FIG. 10, the terminal device 1000 includes a unit 1010 (e.g., a receiving unit) configured to receive, from a network node via RRC signaling, a sidelink configuration to be used by the terminal device while in an RRC_INACTIVE or an RRC_IDLE state. The terminal device 1000 further includes a unit 1020 (e.g., a transmitting unit) configured to perform a sidelink transmission in accordance with the sidelink configuration after transition to the RRC_INACTIVE or RRC_IDLE state.

In an embodiment, the sidelink configuration may include a sidelink resource pool configuration and/or a sidelink QoS configuration.

In an embodiment, the unit 1010 may be further configured to receive from the network node a command to transition from an RRC_CONNECTED state to the RRC_INACTIVE or RRC_IDLE state. The sidelink configuration may be included in the command.

In an embodiment, the terminal device may have an ongoing transmission over a sidelink when the sidelink configuration is received.

In an embodiment, the sidelink configuration may include a grant for the sidelink.

In an embodiment, the sidelink configuration may be to override a sidelink configuration received from the network node via SIB.

Alternatively, the terminal device 1000 can be configured to perform the method 700 as described above in connection with FIG. 7. As shown in FIG. 10, the terminal device 1000 includes a unit 1010 (e.g., a determining unit) configured to determine that a predefined sidelink configuration is enabled in a first cell and/or frequency and/or Radio Access Technology (RAT), and no predefined sidelink configuration is enabled in a second cell and/or frequency and/or RAT, and that no sidelink configuration is available in a SIB from the second cell and/or frequency and/or RAT. The terminal device 1000 further includes a unit 1020 (e.g., a cell selection unit) configured to prioritize the first cell and/or frequency and/or RAT over the second cell and/or frequency and/or RAT in a cell selection or reselection procedure for the terminal device.

In an embodiment, the sidelink configuration may include a sidelink resource pool configuration and/or a sidelink QoS configuration.

The above units 1010-1020 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in any of FIGS. 2, 4, 6 and 7.

FIG. 11 is a block diagram of a terminal device 1100 according to another embodiment of the present disclosure.

The terminal device 1100 includes a processor 1110 and a memory 1120. The terminal device 1100 can further include a transceiver for communication over a sidelink and/or a Uu interface.

The memory 1120 can contain instructions executable by the processor 1110 whereby the terminal device 1100 is operative to perform the actions, e.g., of the procedure described earlier in conjunction with FIG. 2. Particularly, the memory 1120 can contain instructions executable by the processor 1110 whereby the terminal device 1100 is operative to: determine, when the terminal device is in an RRC_CONNECTED state, that one or more RRC state transition conditions associated with a sidelink are met; and transmit to a network node a request to stay in the RRC_CONNECTED state.

In an embodiment, the one or more RRC state transition conditions may include a first condition that no sidelink configuration is available in a SIB from the network node.

In an embodiment, the first condition may further include: no sidelink configuration being available in a SIB from a neighboring cell.

In an embodiment, the first condition may further include: no predefined sidelink configuration being enabled for the terminal device.

In an embodiment, the one or more state transition conditions may include a second condition that there is an ongoing transmission by the terminal device over the sidelink.

In an embodiment, the second condition may further include: the ongoing transmission being associated with a predetermined service type or with a required QoS higher than a QoS threshold.

In an embodiment, the second condition may be determined to be met when a grant for the sidelink has been received from the network node and is currently active.

In an embodiment, the memory 1120 can further contain instructions executable by the processor 1110 whereby the terminal device 1100 is operative to, when the second condition is determined to be met: transmit to the network node a report indicating the ongoing transmission by the terminal device over the sidelink.

In an embodiment, the memory 1120 can further contain instructions executable by the processor 1110 whereby the terminal device 1100 is operative to: receive from the network node an instruction to stay in the RRC_CONNECTED state.

In an embodiment, the sidelink configuration may include a sidelink resource pool configuration and/or a sidelink QoS configuration.

Alternatively, the memory 1120 can contain instructions executable by the processor 1110 whereby the terminal device 1100 is operative to perform the actions, e.g., of the procedure described earlier in conjunction with FIG. 4. Particularly, the memory 1120 can contain instructions executable by the processor 1110 whereby the terminal device 1100 is operative to: determine that a first target cell provides a sidelink configuration in a first SIB and a second target cell provides no sidelink configuration in a second SIB; and transmit to a network node a measurement report containing information on at least one target cell candidate for handover, the information being determined by prioritizing the first target cell over the second target cell.

In an embodiment, the operation of prioritizing may be performed in response to determining that the terminal device does not have any ongoing transmission over a sidelink that is associated with a predetermined service type or with a required QoS higher than a QoS threshold.

In an embodiment, the sidelink configuration may include a sidelink resource pool configuration and/or a sidelink QoS configuration.

Alternatively, the memory 1120 can contain instructions executable by the processor 1110 whereby the terminal device 1100 is operative to perform the actions, e.g., of the procedure described earlier in conjunction with FIG. 6. Particularly, the memory 1120 can contain instructions executable by the processor 1110 whereby the terminal device 1100 is operative to: receive, from a network node via RRC signaling, a sidelink configuration to be used by the terminal device while in an RRC_INACTIVE or an RRC_IDLE state; and perform a sidelink transmission in accordance with the sidelink configuration after transition to the RRC_INACTIVE or RRC_IDLE state.

In an embodiment, the sidelink configuration may include a sidelink resource pool configuration and/or a sidelink QoS configuration.

In an embodiment, the memory 1120 can further contain instructions executable by the processor 1110 whereby the terminal device 1100 is operative to: receive from the network node a command to transition from an RRC_CONNECTED state to the RRC_INACTIVE or RRC_IDLE state. The sidelink configuration may be included in the command.

In an embodiment, the terminal device may have an ongoing transmission over a sidelink when the sidelink configuration is received.

In an embodiment, the sidelink configuration may include a grant for the sidelink.

In an embodiment, the sidelink configuration may be to override a sidelink configuration received from the network node via SIB.

Alternatively, the memory 1120 can contain instructions executable by the processor 1110 whereby the terminal device 1100 is operative to perform the actions, e.g., of the procedure described earlier in conjunction with FIG. 7. Particularly, the memory 1120 can contain instructions executable by the processor 1110 whereby the terminal device 1100 is operative to: determine that a predefined sidelink configuration is enabled in a first cell and/or frequency and/or Radio Access Technology (RAT), and no predefined sidelink configuration is enabled in a second cell and/or frequency and/or RAT, and that no sidelink configuration is available in a SIB from the second cell and/or frequency and/or RAT; and prioritize the first cell and/or frequency and/or RAT over the second cell and/or frequency and/or RAT in a cell selection or reselection procedure for the terminal device.

In an embodiment, the sidelink configuration may include a sidelink resource pool configuration and/or a sidelink QoS configuration.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 910 causes the network node 900 to perform the actions, e.g., of the procedure described earlier in conjunction with any of FIGS. 1, 3 and 5; or code/computer readable instructions, which when executed by the processor 1110 causes the terminal device 1100 to perform the actions, e.g., of the procedure described earlier in conjunction with any of FIGS. 2, 4, 6 and 7.

The computer program product may be configured as a computer program code structured in computer program modules. The computer program modules could essentially perform the actions of the flow illustrated in any of FIGS. 1-7.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

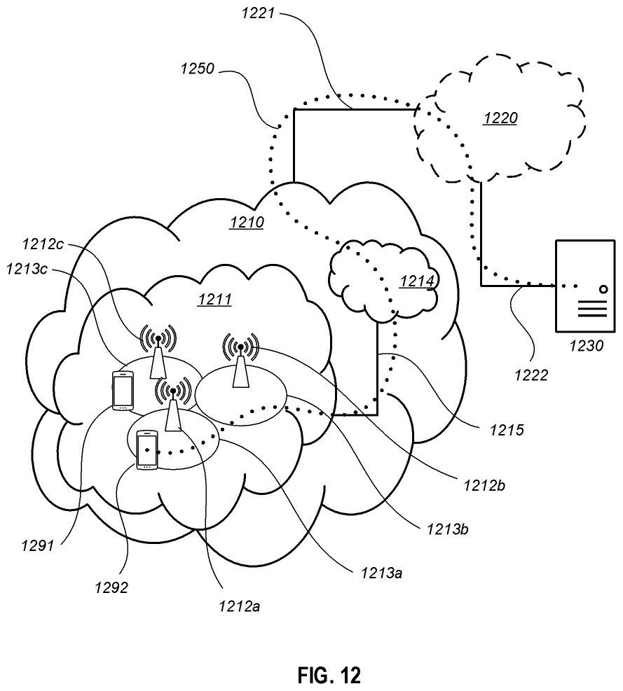

With reference to FIG. 12, in accordance with an embodiment, a communication system includes a telecommunication network 1210, such as a 3GPP-type cellular network, which comprises an access network 1211, such as a radio access network, and a core network 1214. The access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to the core network 1214 over a wired or wireless connection 1215. A first UE 1291 located in a coverage area 1213c is configured to wirelessly connect to, or be paged by, the corresponding base station 1212c. A second UE 1292 in a coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

The telecommunication network 1210 is itself connected to a host computer 1230, which may be embodied in the hardware and/or software of a standalone server, a cloud-implemented server, a distributed server or as processing resources in a server farm. The host computer 1230 may be under the ownership or control of a service provider, or may be operated by the service provider or on behalf of the service provider. Connections 1221 and 1222 between the telecommunication network 1210 and the host computer 1230 may extend directly from the core network 1214 to the host computer 1230 or may go via an optional intermediate network 1220. An intermediate network 1220 may be one of, or a combination of more than one of, a public, private or hosted network; the intermediate network 1220, if any, may be a backbone network or the Internet; in particular, the intermediate network 1220 may comprise two or more sub-networks (not shown).

The communication system of FIG. 12 as a whole enables connectivity between the connected UEs 1291, 1292 and the host computer 1230. The connectivity may be described as an over-the-top (OTT) connection 1250. The host computer 1230 and the connected UEs 1291, 1292 are configured to communicate data and/or signaling via the OTT connection 1250, using the access network 1211, the core network 1214, any intermediate network 1220 and possible further infrastructure (not shown) as intermediaries. The OTT connection 1250 may be transparent in the sense that the participating communication devices through which the OTT connection 1250 passes are unaware of routing of uplink and downlink communications. For example, the base station 1212 may not or need not be informed about the past routing of an incoming downlink communication with data originating from the host computer 1230 to be forwarded (e.g., handed over) to a connected UE 1291. Similarly, the base station 1212 need not be aware of the future routing of an outgoing uplink communication originating from the UE 1291 towards the host computer 1230.

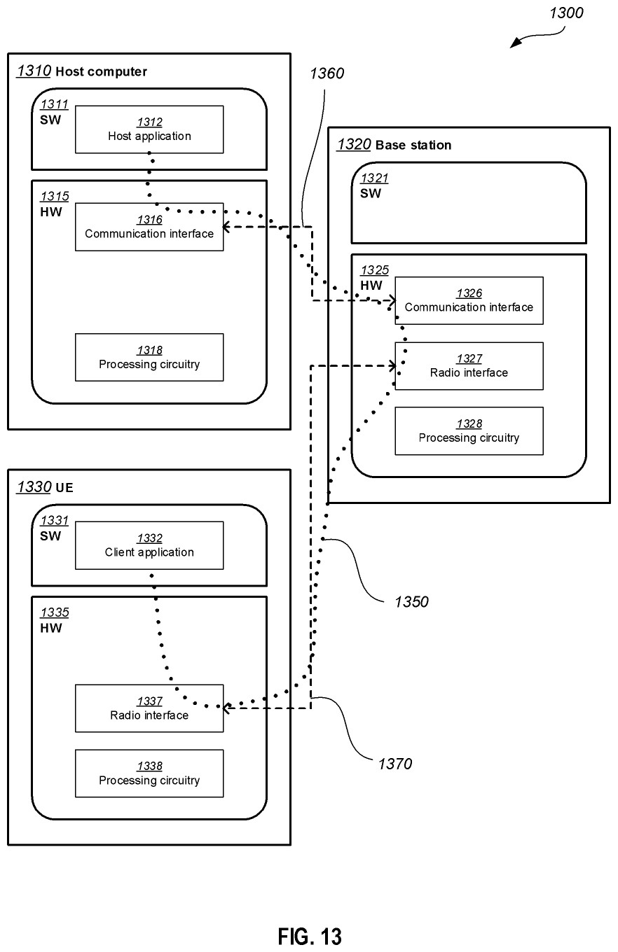

Example implementations, in accordance with an embodiment, of the UE, base station and host computer discussed in the preceding paragraphs will now be described with reference to FIG. 13. In a communication system 1300, a host computer 1310 comprises hardware 1315 including a communication interface 1316 configured to set up and maintain a wired or wireless connection with an interface of a different communication device of the communication system 1300. The host computer 1310 further comprises a processing circuitry 1318, which may have storage and/or processing capabilities. In particular, the processing circuitry 1318 may comprise one or more programmable processors, application-specific integrated circuits, field programmable gate arrays or combinations of these (not shown) adapted to execute instructions. The host computer 1310 further comprises software 1311, which is stored in or accessible by the host computer 1310 and executable by the processing circuitry 1318. The software 1311 includes a host application 1312. The host application 1312 may be operable to provide a service to a remote user, such as UE 1330 connecting via an OTT connection 1350 terminating at the UE 1330 and the host computer 1310. In providing the service to the remote user, the host application 1312 may provide user data which is transmitted using the OTT connection 1350.

The communication system 1300 further includes a base station 1320 provided in a telecommunication system and comprising hardware 1325 enabling it to communicate with the host computer 1310 and with the UE 1330. The hardware 1325 may include a communication interface 1326 for setting up and maintaining a wired or wireless connection with an interface of a different communication device of the communication system 1300, as well as a radio interface 1327 for setting up and maintaining at least a wireless connection 1370 with the UE 1330 located in a coverage area (not shown in FIG. 13) served by the base station 1320. The communication interface 1326 may be configured to facilitate a connection 1360 to the host computer 1310. The connection 1360 may be direct or it may pass through a core network (not shown in FIG. 13) of the telecommunication system and/or through one or more intermediate networks outside the telecommunication system. In the embodiment shown, the hardware 1325 of the base station 1320 further includes a processing circuitry 1328, which may comprise one or more programmable processors, application-specific integrated circuits, field programmable gate arrays or combinations of these (not shown) adapted to execute instructions. The base station 1320 further has software 1321 stored internally or accessible via an external connection.

The communication system 1300 further includes the UE 1330 already referred to. Its hardware 1335 may include a radio interface 1337 configured to set up and maintain a wireless connection 1370 with a base station serving a coverage area in which the UE 1330 is currently located. The hardware 1335 of the UE 1330 further includes a processing circuitry 1338, which may comprise one or more programmable processors, application-specific integrated circuits, field programmable gate arrays or combinations of these (not shown) adapted to execute instructions. The UE 1330 further comprises software 1331, which is stored in or accessible by the UE 1330 and executable by the processing circuitry 1338. The software 1331 includes a client application 1332. The client application 1332 may be operable to provide a service to a human or non-human user via the UE 1330, with the support of the host computer 1310. In the host computer 1310, an executing host application 1312 may communicate with the executing client application 1332 via the OTT connection 1350 terminating at the UE 1330 and the host computer 1310. In providing the service to the user, the client application 1332 may receive request data from the host application 1312 and provide user data in response to the request data. The OTT connection 1350 may transfer both the request data and the user data. The client application 1332 may interact with the user to generate the user data that it provides.

It is noted that the host computer 1310, the base station 1320 and the UE 1330 illustrated in FIG. 13 may be similar or identical to the host computer 1930, one of base stations 1912a, 1912b, 1912c and one of UEs 1991, 1992 of FIG. 12, respectively. This is to say, the inner workings of these entities may be as shown in FIG. 13 and independently, the surrounding network topology may be that of FIG. 12.

In FIG. 13, the OTT connection 1350 has been drawn abstractly to illustrate the communication between the host computer 1310 and the UE 1330 via the base station 1320, without explicit reference to any intermediary devices and the precise routing of messages via these devices. Network infrastructure may determine the routing, which it may be configured to hide from the UE 1330 or from the service provider operating the host computer 1310, or both. While the OTT connection 1350 is active, the network infrastructure may further take decisions by which it dynamically changes the routing (e.g., on the basis of load balancing consideration or reconfiguration of the network).

Wireless connection 1370 between the UE 1330 and the base station 1320 is in accordance with the teachings of the embodiments described throughout this disclosure. One or more of the various embodiments improve the performance of OTT services provided to the UE 1330 using the OTT connection 1350, in which the wireless connection 1370 forms the last segment. More precisely, the teachings of these embodiments may improve the QoS in terms of data rate and latency, and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1350 between the host computer 1310 and the UE 1330, in response to variations in the measurement results. The measurement procedure and/or the network functionality for reconfiguring the OTT connection 1350 may be implemented in software 1311 and hardware 1315 of the host computer 1310 or in software 1331 and hardware 1335 of the UE 1330, or both. In embodiments, sensors (not shown) may be deployed in or in association with communication devices through which the OTT connection 1350 passes; the sensors may participate in the measurement procedure by supplying values of the monitored quantities exemplified above, or supplying values of other physical quantities from which the software 1311, 1331 may compute or estimate the monitored quantities. The reconfiguring of the OTT connection 1350 may include message format, retransmission settings, preferred routing etc.; the reconfiguring need not affect the base station 1320, and it may be unknown or imperceptible to the base station 1320. Such procedures and functionalities may be known and practiced in the art. In certain embodiments, measurements may involve proprietary UE signaling facilitating the host computer 1310's measurements of throughput, propagation times, latency and the like. The measurements may be implemented in that the software 1311 and 1331 causes messages to be transmitted, in particular empty or ‘dummy’ messages, using the OTT connection 1350 while it monitors propagation times, errors etc.

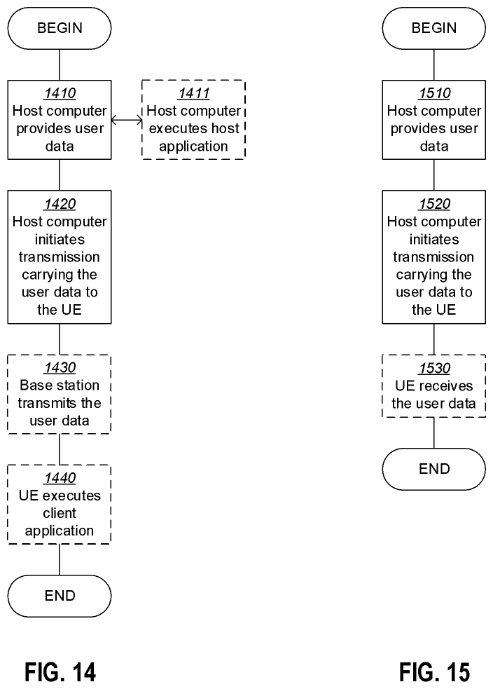

FIG. 14 is a flowchart illustrating a method implemented in a communication system, in accordance with an embodiment. The communication system includes a host computer, a base station and a UE which may be those described with reference to FIG. 12 and FIG. 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

FIG. 15 is a flowchart illustrating a method implemented in a communication system, in accordance with an embodiment. The communication system includes a host computer, a base station and a UE which may be those described with reference to FIG. 12 and FIG. 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE.

The transmission may pass via the base station, in accordance with the teachings of the embodiments described throughout this disclosure. In step 1530 (which may be optional), the UE receives the user data carried in the transmission.

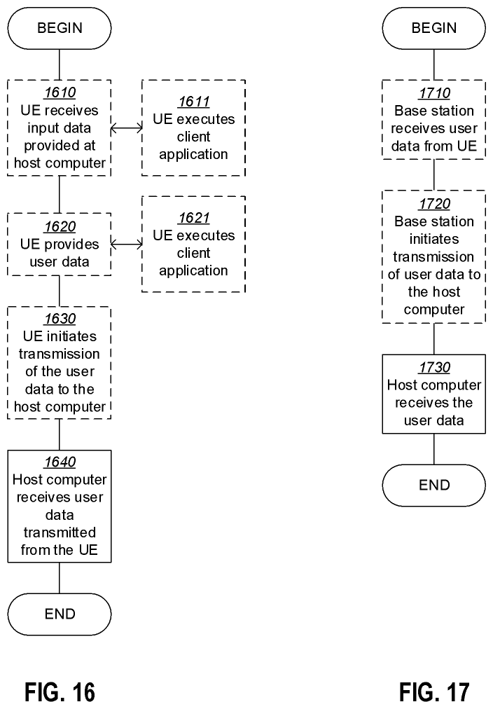

FIG. 16 is a flowchart illustrating a method implemented in a communication system, in accordance with an embodiment. The communication system includes a host computer, a base station and a UE which may be those described with reference to FIG. 12 and FIG. 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

FIG. 17 is a flowchart illustrating a method implemented in a communication system, in accordance with an embodiment. The communication system includes a host computer, a base station and a UE which may be those described with reference to FIG. 12 and FIG. 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

Hereinafter, the solutions will be further described as follows.

V2X

In Rel-14 and Rel-15, the extensions for the device-to-device work consist of support of V2X communication, which includes any combination of direct communication between vehicles, pedestrians and infrastructure. V2X communication may take advantage of a network (NW) infrastructure, when available, but at least basic V2X connectivity should be possible even in case of lack of coverage. Providing an LTE-based V2X interface may be economically advantageous because of the LTE economies of scale and it may enable tighter integration between communications with the NW infrastructure (V2I), pedestrian (V2P) and other vehicles (V2V), as compared to using a dedicated V2X technology (e.g., IEEE 802.11p).

V2X communications may carry both non-safety and safety information, where each of the applications and services may be associated with specific requirements sets, e.g., in terms of latency, reliability, data rates etc.

There are several different use cases defined for V2X:
V2V (vehicle-to-vehicle): covering LTE-based communication between vehicles, either via the cellular interface (known as Uu) or via the sidelink interface (known as PC5).
V2P (vehicle-to-pedestrian): covering LTE-based communication between a vehicle and a device carried by an individual (e.g., handheld terminal carried by a pedestrian, cyclist, driver or passenger), either via Uu or sidelink (PC5)
V2I/N (vehicle-to-infrastructure/network): covering LTE-based communication between a vehicle and a roadside unit/network. A roadside unit (RSU) is a transportation infrastructure entity (e.g., an entity transmitting speed notifications) that communicates with V2X capable UEs over sidelink (PC5) or over Uu. For V2N, the communication is performed on Uu.

NR V2X Enhancements

3GPP SA1 working group has completed new service requirements for future V2X services in the FS_eV2X. SA1 have identified 25 use cases for advanced V2X services which will be used in 5G (i.e. LTE and NR). Such use cases are categorized into four use case groups: vehicles platooning, extended sensors, advanced driving and remote driving. Direct unicast transmission over sidelink will be needed in some use cases such as platooning, cooperative driving, dynamic ride sharing, etc. For these advanced applications the expected requirements to meet the needed data rate, capacity, reliability, latency, communication range and speed are more stringent. The consolidated requirements for each use case group are captured in TR 22.886.

UE RRC States

A UE is in either RRC_CONNECTED state, RRC_INACTIVE state or RRC_IDLE state. In RRC_INACTIVE and RRC_IDLE state, UE controlled mobility based on network configuration is adopted, UE acquires SIB, performs neighboring cell measurements and cell (re-)selection, and monitors a Paging. An inactive UE stores the UE Inactive AS context and performs RAN-based notification area updates. In RRC_CONNECTED state. Network controlled mobility is performed, UE is known by the NW at node/cell level, UE specific bearer is established upon which UE specific data and/or control signaling could be communicated.

If, e.g., there is no traffic transmission and/or reception for a certain timer period, the network initiates the RRC connection release procedure to transit a UE in RRC_CONNECTED to RRC_IDLE; or to RRC_INACTIVE if SRB2 and at least one DRB is setup in RRC_CONNECTED.

Sidelink Resource Allocation

There are two different resource allocation (RA) procedures for V2X on sidelink, i.e., NW controlled RA (so called “mode 3” in LTE and “mode 1” in NR) and autonomous RA (so called “mode 4” in LTE and “mode 2” in NR). The transmission resources are selected within a resource pool which is predefined or configured by the network (NW).

With NW controlled RA, the sidelink radio resource for data transmission is scheduled/allocated by the NW. The UE sends sidelink BSR to the NW to inform sidelink data available for transmission in the sidelink buffers associated with the MAC entity, and the NW signals the resource allocation to the UE using DCI. With autonomous RA, each device independently decides which radio resources to use for each transmission based on e.g., sensing. For both RA modes a sidelink control information (SCI) is transmitted on physical sidelink control channel (PSCCH) to indicate the assigned sidelink resources for physical sidelink shared channel (PSSCH).

NW controlled RA can only be performed when UE is in RRC_CONNECTED, autonomous RA can be performed in all RRC states. If sidelink resource pool configurations are not provided in SIB, an in-coverage UE will need to enter RRC_CONNECTED state to obtain pool configurations via dedicated RRC signaling, in which case the pool could be configured exclusively.

Configured grant is supported for NR sidelink, for both type 1 and type 2. With configured grant the gNB can allocate sidelink resources for multiple (periodical) transmissions to the UE. Type 1 configured grant is configured and activated directly via dedicated RRC signaling, type 2 configured grant is configured via dedicated RRC signaling, but only activated/released via DCI transmitted on PDCCH,

A UE in RRC_CONNECTED will be transited to RRC_IDLE or RRC_INACTIVE if e.g., no traffic transmission and/or reception happens over the Uu interface for a certain time period, even if there is a SL transmission ongoing. Further, if a UE is in RRC_IDLE or RRC_INACTIVE, and sidelink resource pool configurations are not provided in SIB, the UE will need to enter RRC_CONNECTED state to obtain pool configurations via dedicated RRC signaling. This will cause some ping-pang effect, i.e., the UE repeatedly switches between RRC_CONNECTED and RRC_IDLE/RRC_INACTIVE if e.g., no Uu traffic and (type 1) configured grant or mode 2 RA is adopted for sidelink.

Besides, it is easier to guarantee sidelink performance when UE is in RRC_CONNECTED as exclusive resource pool could be configured. In fact, transiting a UE in RRC_CONNECTED to RRC_IDLE or RRC_INACTIVE due to e.g., inactivity over Uu link may cause a degradation in sidelink performance, which is undesirable, especially for (safety related) (e)V2X services requiring high QoS.

This disclosure proposes methods to optimize UE RRC state transition with the presence of sidelink. The key inventive points include:
Considering both Uu and sidelink situation in UE RRC state transition.
   Considering the Uu and sidelink situation in the serving cell/node
   Considering (also) the sidelink situation in neighbor cell/node.
Optimization of handover to facilitate desired RRC state transition.
Optimization of cell (re)selection to avoid unnecessary UE RRC state transition.

With the methods proposed in this IVD repeated switching between different RRC states could be avoided, also the degradation in the performance of critical (e)V2X services running over sidelink could be avoided. Besides, the UE could be kept in or quickly transited to RRC_IDLE or RRC_INACTIVE when no benefits from having the UE in RRC_CONNECTED.

This invention may be applied to LTE, NR, or any RAT.

The main idea is considering both Uu and sidelink situation in UE RRC state transition. More specifically, an (in-coverage) UE should be kept in RRC_CONNECTED state if any of the following conditions is met:
The current Uu based condition(s) for state transition to RRC_IDLE/RRC_INACTIVE (e.g., the inactivity timer is not expired yet) is not met,
No sidelink resource pool and/or sidelink QoS configurations are provided in SIB,
Configured SL grant has been provided to UE and has not been deactivated,
The (e)V2X service(s) running over sidelink have high QoS requirement, e.g., high reliability requirement, which is hard to be met if the UE is not in RRC_CONNECTED state.
   The NW could configure by dedicated or common signaling that which (type of) services running over sidelink requires the UE to be in RRC_CONNECTED state (when in coverage), this could also be predefined in UE.
   The NW could know the (type of) (e)V2X service(s) via e.g., SidelinkUEInformation reported by the UE.

The above conditions (at least the sidelink related conditions) could be configured by the NW via dedicated or common signaling, or predefined in the UE.

Keeping a UE in RRC_CONNECTED state may be realized in the following ways:
Modifying the Uu inactivity timer, e.g., set a sufficiently large value, or configure a special value which corresponds to infinite (i.e. the timer will never expire), or
Ignore the current Uu based condition(s) for state transition to RRC_IDLE/RRC_INACTIVE if any of the sidelink related condition(s) for keeping the UE in RRC_CONNECTED is met and the UE is in coverage.
The NW explicitly informs the UE to stay in RRC_CONNECTED state (as long as the UE is in coverage) if any of the sidelink related condition(s) for keeping the UE in RRC_CONNECTED is met.

As a further enhancement, if there exist (neighbor) cell(s) in the same and/or different frequenc(ies) and/or RAT(s) which provide sidelink resource pool and optionally also sidelink QoS configurations in SIB, and the UE could find a suitable cell to camp on from those) cell(s), the UE could be transited to RRC_IDLE or RRC_INACTIVE if the Uu based condition(s) for state transition to RRC_IDLE or RRC_INACTIVE are met, and there are no service(s) running over sidelink and require the UE to be in RRC_CONNECTED state, even the current serving cell/node does not provide sidelink resource pool and/or sidelink QoS configurations in SIB.

Whether an intra/inter frequency/RAT (neighbor) cells providing sidelink resource pool and/or sidelink QoS configurations could be indicated by the serving cell/node via dedicated and/or common control signaling, or the UE could obtain this info by itself via reading SIB(s) from the (neighbor) cells. In the latter case, the UE may inform this info to its serving cell/node, to aid the serving cell/node to properly handle the RRC state transition for the UE.

Besides, during handover, higher priority may be given to the cell(s) which provide sidelink resource pool and optionally also sidelink QoS configurations in SIB, optionally only when there are no service(s) running over sidelink and requiring the UE to be in RRC_CONNECTED state, and/or the Uu based condition(s) for state transition to RRC_IDLE or RRC_INACTIVE are (going to be) met. By this the UE could be (more quickly) transited to RRC_IDLE or RRC_INACTIVE (in e.g., the target cell) when desired and thus save UE power consumption.

Further, the NW could indicate whether predefined sidelink configurations on e.g., resource pool and QoS could be used in certain sidelink frequency (frequencies) and/or RAT(s) when an (in-coverage) UE is in RRC_IDLE or RRC_INACTIVE, if this is the case, a UE in RRC_IDLE or RRC_INACTIVE and operating sidelink in the indicated sidelink frequency (frequencies) and/or RAT(s) needs not enter RRC_CONNECTED even if the relevant sidelink configurations are not provided in SIB. On the other hand, a UE in RRC_CONNECTED and operating sidelink in the indicated sidelink frequency (frequencies) and/or RAT(s) may be transited to RRC_IDLE or RRC_INACTIVE and uses predefined sidelink configurations.

In cell (re)selection, a V2X capable UE may prioritize the frequency (frequencies) and/or RAT(s) where predefined sidelink configurations are allowed to be used over the frequency (frequencies) and/or RAT(s) where predefined sidelink configurations are not allowed to be used and no sidelink configurations are provided (in SIB). By this unnecessary RRC state transition to RRC_CONNECTED could be avoided.

In one embodiment, when NW transfers UE from RRC_CONNECTED state to RRC_INACTIVE/IDLE state, NW also provides Sidelink (SL) configurations for SL transmissions/receptions in RRC_INACTIVE/IDLE state via RRC signaling. The received SL configuration for RRC_INACTIVE/IDLE state, i.e. via RRC signaling during RRC state transfer, will override what is conveyed in SIB message and received by UE after entering RRC_INACTIVE/IDLE state. UE will keep using the provided SL configuration when in RRC_INACTIVE/IDLE state until the UE enters RRC_CONNECTED state again or moves out of coverage.

For example, in case there are on-going mode 1 SL operations but no Uu traffic, NW may still transfer the RRC_CONNECTED UE to RRC_INACTIVE/IDLE state with given dedicated SL resource pool.

The SL configuration for RRC_INACTIVE/IDLE state may include any of the following (but not limited to):
SL Configured grant
SL TX/RX resource pool
SL QoS flow and SLRB configuration including:
   QoS parameters associated with each SL QoS flow
   SL QoS flow to SLRB mapping.

1. A method in a network node, comprising:
determining, when a terminal device is in a Radio Resource Control, RRC, _CONNECTED state, that one or more RRC state transition conditions associated with a sidelink are met; and
keeping the terminal device in the RRC_CONNECTED state.

2. The method of claim 1, wherein the one or more RRC state transition conditions comprise a first condition that no sidelink configuration is available in a System Information Broadcast, SIB, from the network node.

3. The method of claim 2, wherein the first condition further comprises: no sidelink configuration being available in a SIB from a neighboring cell.

4. The method of claim 2, wherein the first condition further comprises:
no predefined sidelink configuration being enabled for the terminal device.

5. The method of claim 1, wherein the one or more state transition conditions comprise a second condition that there is an ongoing transmission by the terminal device over the sidelink.

6. The method of claim 5, wherein the second condition further comprises:
the ongoing transmission being associated with a predetermined service type or with a required Quality of Service, QoS, higher than a QoS threshold.

7. The method of claim 5, wherein the second condition is determined to be met when:
a grant for the sidelink has been provided to the terminal device and is currently active, or
a report is received from the terminal device, indicating the ongoing transmission by the terminal device over the sidelink.

8. The method of claim 1, wherein said keeping comprises one or more of:
setting an inactivity timer to a value larger than a timer value threshold, wherein the inactivity timer is associated with an interface between the network node and the terminal device,
refraining from initiating an RRC state transition of the terminal device when the inactivity timer expires, or
instructing the terminal device to stay in the RRC_CONNECTED state.

9. The method of claim 1, wherein the sidelink configuration comprises a sidelink resource pool configuration and/or a sidelink QoS configuration.

10. A method in a terminal device, comprising:
determining, when the terminal device is in a Radio Resource Control, RRC, _CONNECTED state, that one or more RRC state transition conditions associated with a sidelink are met; and
transmitting to a network node a request to stay in the RRC_CONNECTED state.

11. The method of claim 10, wherein the one or more RRC state transition conditions comprise a first condition that no sidelink configuration is available in a System Information Broadcast, SIB, from the network node.

12. The method of claim 11, wherein the first condition further comprises:
no sidelink configuration being available in a SIB from a neighboring cell.

13. The method of claim 11, wherein the first condition further comprises:
no predefined sidelink configuration being enabled for the terminal device.

14. The method of claim 10, wherein the one or more state transition conditions comprise a second condition that there is an ongoing transmission by the terminal device over the sidelink.

15. The method of claim 14, wherein the second condition further comprises: the ongoing transmission being associated with a predetermined service type or with a required Quality of Service, QoS, higher than a QoS threshold.

16. The method of claim 14, wherein the second condition is determined to be met when a grant for the sidelink has been received from the network node and is currently active.

17. The method of claim 14, further comprising, when the second condition is determined to be met:
transmitting to the network node a report indicating the ongoing transmission by the terminal device over the sidelink.

18. The method of claim 10, further comprising:
receiving from the network node an instruction to stay in the RRC_CONNECTED state.

19. The method of claim 10, wherein the sidelink configuration comprises a sidelink resource pool configuration and/or a sidelink QoS configuration. cm 20-51. (canceled)

52. A terminal device, comprising a processor and a memory, the memory comprising instructions executable by the processor whereby the terminal device is operative to:
determine, when the terminal device is in a Radio Resource Control, RRC, _CONNECTED state, that one or more RRC state transition conditions associated with a sidelink are met; and
transmit to a network node a request to stay in the RRC_CONNECTED state.

53-67. (canceled)
